(19) United States
(12) Patent Application Publication
(10) Pub. No.: US 2004/0222363 A1
(43) Pub. Date: Nov. 11, 2004

(54) Connectorized optical component misalignment detection system

(75) Inventors: Andre R. Lalonde, Allen, TX (US); Rick S. Williams, Rowlett, TX (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Honeywell International Inc.

(21) Appl. No.: 10/430,941

(22) Filed: May 7, 2003

(51) Int. Cl. G01J 1/04

(52) U.S. Cl. 250/227.14

(57) ABSTRACT

A misalignment detection system for checking the coupling of a component and a medium via a receptacle of a connectorized arrangement. Power coupling measurements between an optical component and a fiber are presented as illustrative examples of the invention. A ferrule of a fiber is inserted into a bore of a receptacle that has the component attached to the end of the receptacle opposite of the bore. The ferrule of the fiber is attached to a support structure having an absorber spring between the structure and ferrule. A first force is applied pressing the ferrule into the bore. Also, a rotating force orthogonal to the first force is applied to the structure causing the ferrule to wiggle in the bore. Power measurements are taken while the first force is applied and then also while the rotating force is applied.

### BACKGROUND

The invention pertains to connections and alignment of the respective components and the media connected to each other. Receptacles may be used for such connections. However, when components are aligned into receptacles, there are potential problems that may arise. There are problems of coupling of power and alignment of the optical component with its medium via a receptacle. This makes for an inefficient system.

### SUMMARY OF THE INVENTION

The present invention may provide verification and feedback on how poorly or effectively a component, e.g., a VCSEL device, is aligned by measuring medium-coupled power and measuring power a number of times while the medium such as a fiber is moved within the receptacle holding the component. This test may better assure the elimination of problems related to component, receptacle and medium connected assemblies. The component may instead be a detector.

### BRIEF DESCRIPTION OF THE DRAWINGS

FIG. 1 is a plan view of an illustrative example of a connectorized optical component misalignment detection system.

FIG. 2 is a side view of the system of FIG. 1.

FIG. 3 is the system of FIG. 1 with the fiber ferrule inserted in the bore of a receptacle holding an optical component.

FIG. 4 is the system of FIG. 1 set up for a deviation of alignment function.

FIGS. 5a and 5b show the plan and side views, respectively, of a rotating lateral force mechanism.

FIGS. 6a and 6b are diagrams of the rotating force vector and the relationship of the various force vectors.

FIG. 7 is an arrangement for measuring total output power of a component in a receptacle.

### DESCRIPTION

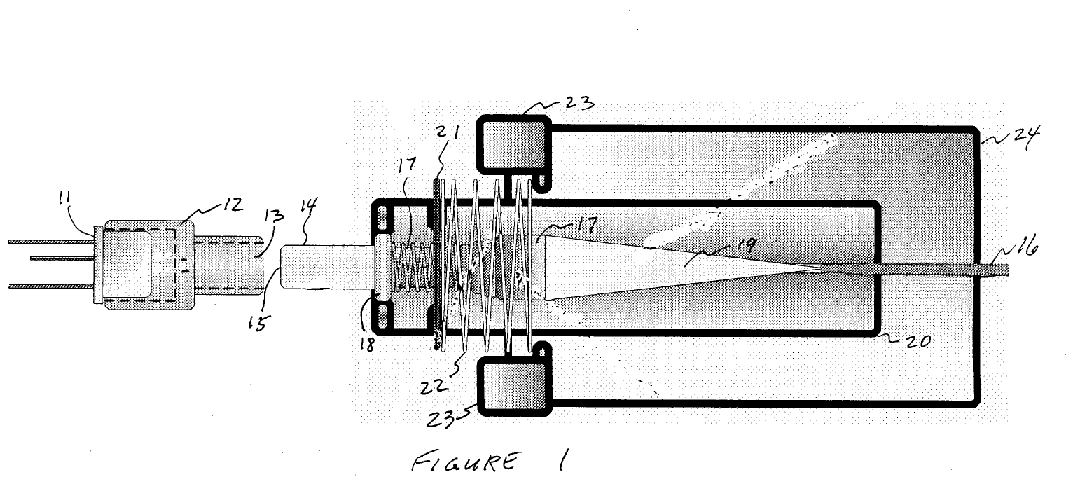

FIG. 1 shows an illustrative example of an application of the invention. An optical component 11 is inserted into a receptacle 12. Optical component 11 may be a light source such as a vertical cavity surface emitting laser (VCSEL) or the like, or it may be a photo detector. Receptacle 12 may be molded from plastic or other material. Component 11 may be glued into an opening fitted for that kind of component. The glue may be on epoxy or other adequate adhering substance. At the other end of receptacle 12 may be a bored round opening 13 which is fitted to receive an optical fiber ferrule 14. Opening 13 could be square or any other shape. Ferrule 14 may fit in opening or bore 13 somewhat precise and snug. Yet ferrule 14 may be easily removable from bore 13. Ferrule 14 is typically made from a ceramic material and may be available as part of fiber 16 for purchase in the market place. An end face 15 of ferrule 14, when inserted, faces component 11. In the center of ferrule 14, there may be a small opening in which an end of the optical fiber 16 may be present. There may be an opening 17 between component 11 and the inner surface of bore 13 for the conveyance of radiation or light between component 11 and fiber 16 in ferrule 14. Ferrule 14 may be fitted on or in and attached to a metal shaft or tube 17. At the connection of ferrule 14 and tube 17 may be situated a metal nut or ring 18. Shaft 17 may be press-fitted into nut 18. Shaft 17 may be made or machined from steel or other metal or material. Likewise, nut 18 may be made or machined from steel or other metal or material. Through the center of shaft 17 may be a hole that holds or houses fiber 16. On the other end of shaft 17 opposite from the nut 18 and ferrule 14 end may be attached a strain relief 19 which provides strain relief and protection for optical fiber 16. Strain relief 19 may be of a plastic, rubber or like flexible material. Strain relief 19 may help prevent fiber 16 from being overly bent or broken under movement. Parts 14, 16, 17 and 19 may be purchased as a combined assembly available in the market place.

Ferrule 14 may have a bare fiber core of fiber 16 at about the center of the face of ferrule 14 facing bore 13. The face of ferrule 14 may be ceramic as well as the rest of the ferrule except that a small hole in the face allows for exposure of an end of the bare fiber core. An instance of the diameter of the optical fiber core may be about 50 microns or 62.5 microns. The core of fiber 16 may be aligned with a small emitting or detecting area of component 11. This area could be as small as or smaller than the area of the end of the fiber core. Fiber 16 may have a cladding around its core which may result in the fiber having a diameter of about 125 microns. To protect the fiber more and provide durability, fiber 16 may also have a protective sheath around it.

Formed, machined or made from steel or other metal or material may be a fiber 16 support block or cylinder 20 that has an opening which is clamped on and around nut 18. At the other end of cylinder 20 may be a hole through which fiber 16 is threaded. Cylinder 20 contains shaft 17, relief 19 and optical fiber 16. Around cylinder 20 towards the end on nut 18, is a groove in which a retaining ring 21 may be inserted or snapped into place. Slipped on to cylinder 20 from the end opposite of nut 18 may be a support spring 22. Spring 22 may be against retaining ring 21, which prevents spring 22 from slipping past it to the end of cylinder 20 at nut 18. Against the other end of spring 22 may be a bracket 23. As bracket 23 is moved towards spring 22 and cylinder 20 remains stationary, bracket 23 may compress spring 22.

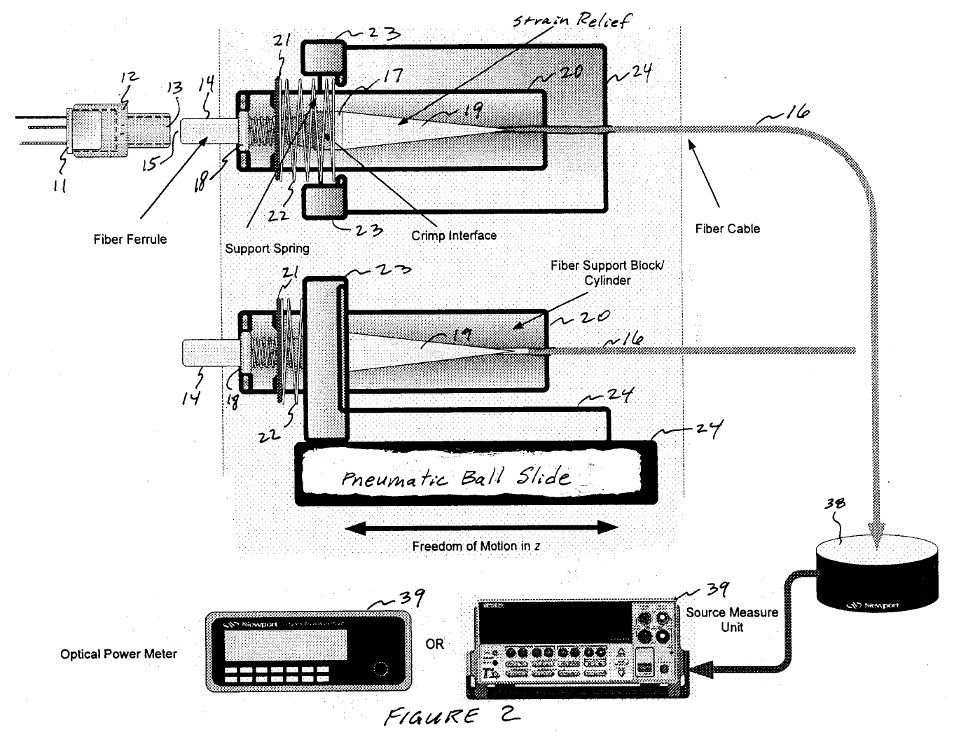

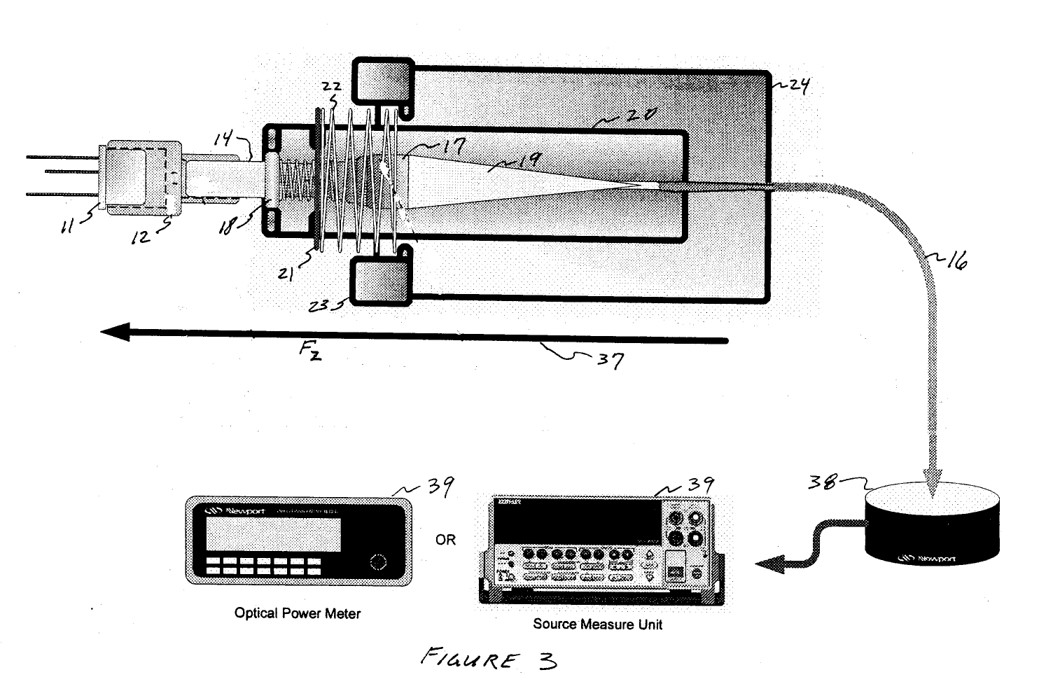

Attached to bracket 23 may be a pneumatic ball slide 24 which can move bracket 23 toward spring 22, as shown in FIG. 2. If cylinder 20 is free to move, slide 24 via bracket 23 and spring 22 may move cylinder 20 along with ferrule 14 of fiber 16 in a “z” direction towards receptacle 12 and ferrule 14 is pushed into bore 13 of receptacle 12 as shown in FIG. 3. Ferrule 14 is held in receptacle 12 with a constant force in the z direction. Spring 22 provides a cushion between bracket 23 and cylinder 20. This cushion effect may prevent possible breakage of ferrule 14 or receptacle 12 upon their coming together. With this constant “z” force, there is no force that is orthogonal to the z direction being applied to cylinder 20 and ferrule 14. The stopping point for ferrule 14 is the end of the bore in receptacle 12.

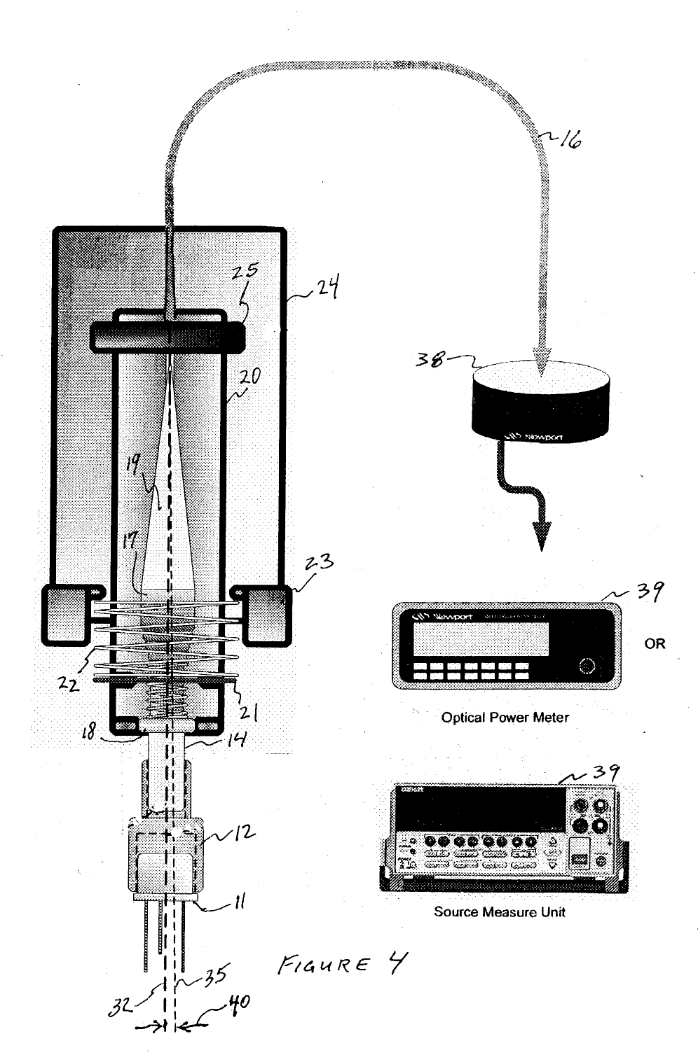

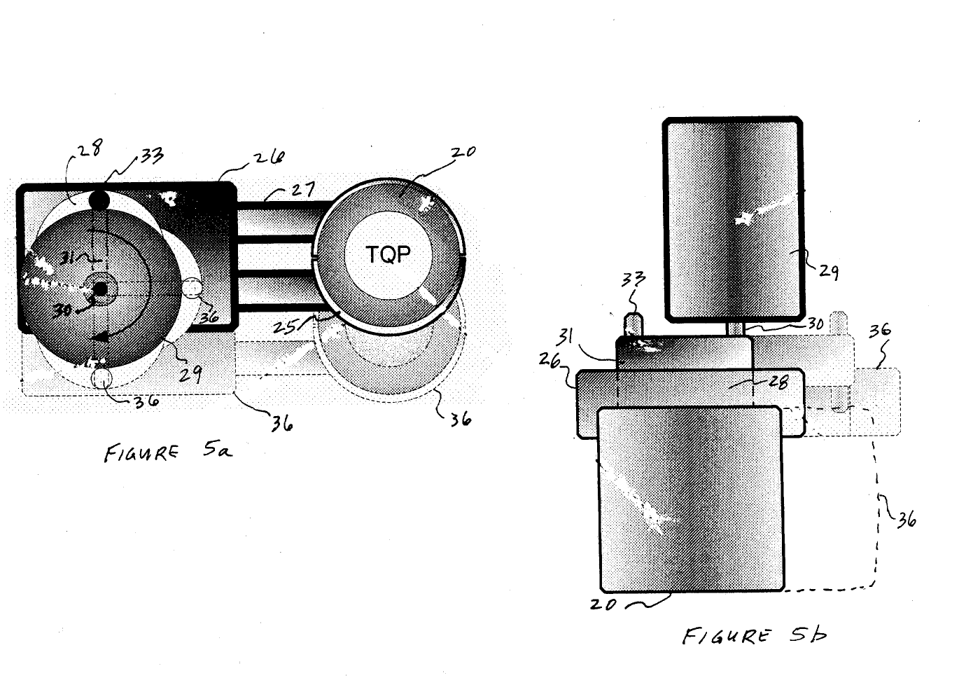

In FIG. 4, a mechanism for applying in x and y directions (orthogonal to the z direction) forces to ferrule 14 in bore 13 of receptacle 12 is illustrated by way of an example. Near the end of cylinder 20 opposite from the end at ferrule 14, is a mechanical ring-like grip 25 fixed around cylinder 20. Attached to grip 25 is a block 26 via bar links 27, as shown in FIGS. 5a and 5b. Block 26 has a hole 28 having a shape of a nearly perfect circle. Positioned proximate to block 26 is a motor 29. Motor 29 is situated with its shaft 30 at the center of circular hole 28. Without any orthogonal forces applied in the x and y directions, the motor shaft 30 may be aligned with a center axis 32 (FIG. 4). Connected to shaft 30 is a connecting rod or bar 31. On rod or bar 31 is a plug, pin, slider roller or slider, roller or plug 33 that rides on or slides against an inside surface of circular hole 28. Pin or plug 33 moves block 26 a slight distance or the center of hole 28 off center axis 32 by a small amount of distance, for example, about one eighth of an inch, i.e., about 3 millimeters. Hole 28 may be about one inch in diameter. The small amount of distance that block 26 is shifted in a direction that rotates in a circle relative to the z direction or center axis 32. This movement translates in to a force 34 that has a direction orthogonal to center axis 32 or z direction. Plug 33 may be removed from its hole or slot in connecting rod or bar 31 and placed in another hole or slot of rod or bar 31 to provide an adjustment of the amount of movement or resultant force 34. Likewise, a block 26 with a smaller or large hole 28 may be utilized for block 26 or force 34 adjustment. Force 34 causes ceramic ferrule 14 in hole or bore 13 to wiggle. There is a deviation axis 35 of tilt or wiggle of ferrule 14, shaft 17 and cylinder 20 that may occur relative to center axis 32 of component 11, receptacle 12 and bore 13. This deviation 40 may be about several mils at the base of receptacle 12 furthest from ferrule 14. Deviation axis 35 may be aligned or coincide with axis 32 when there is no force 34 and no tilt or wiggle of ferrule 14 along with its associated parts such as shaft 17 and cylinder 20.

FIG. 5a reveals a top view of the motor 29 and block 26 assembly relative to cylinder 20. FIG. 5b reveals a side view of the motor 29 and block 26 assembly. Alternate shifted position 36 of block 26, hole 28 and cylinder 20 is shown from the top in FIG. 5a and from the side in FIG. 5b, due to rotation of connecting rod 31 and plug 33 against the inside surface of hole 28. Parts 26, 28 and 20 shift around in a rather small circle relative to the nearly perfectly machined circle of the inside wall of hole 28. The amount of deviation of axis 35 is set by hole 28, the hole 28 center and diameter, and the center position of motor shaft 30 relative to axis 32, and the distance of plug 33 on connecting rod 31 from the center of motor shaft 30. These dimensions and settings are selected with design calculations and a series of trials with various ferrules, receptacles and components.

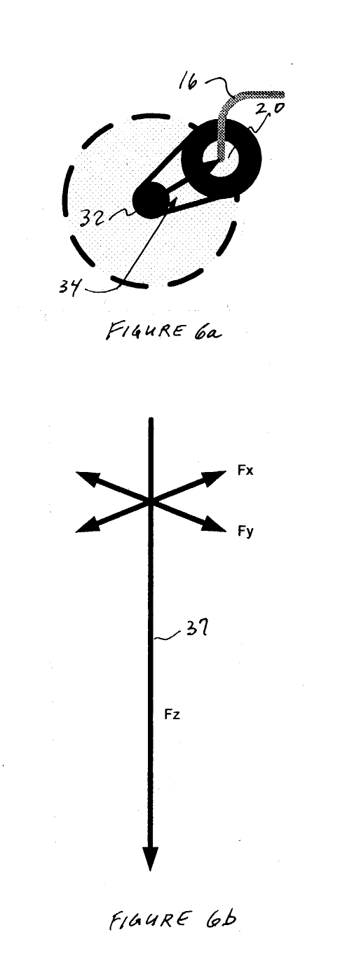

FIGS. 6a and 6b are vector diagrams showing the forces applied to ferrule 14 via cylinder 20, grip 25, bar 27 and block 26, and retainer 21, spring 22, bracket 23 and pneumatic ball slide 24. Forces orthogonal to the z direction are provided by force 34 vector that rotates about axis 32. The force in the z direction may be regarded as a force 37. The z direction may coincide with center axis 32. Force 34 may be in an x or y direction or somewhere in between. The direction of force 34 may be dynamic as its vector rotates.

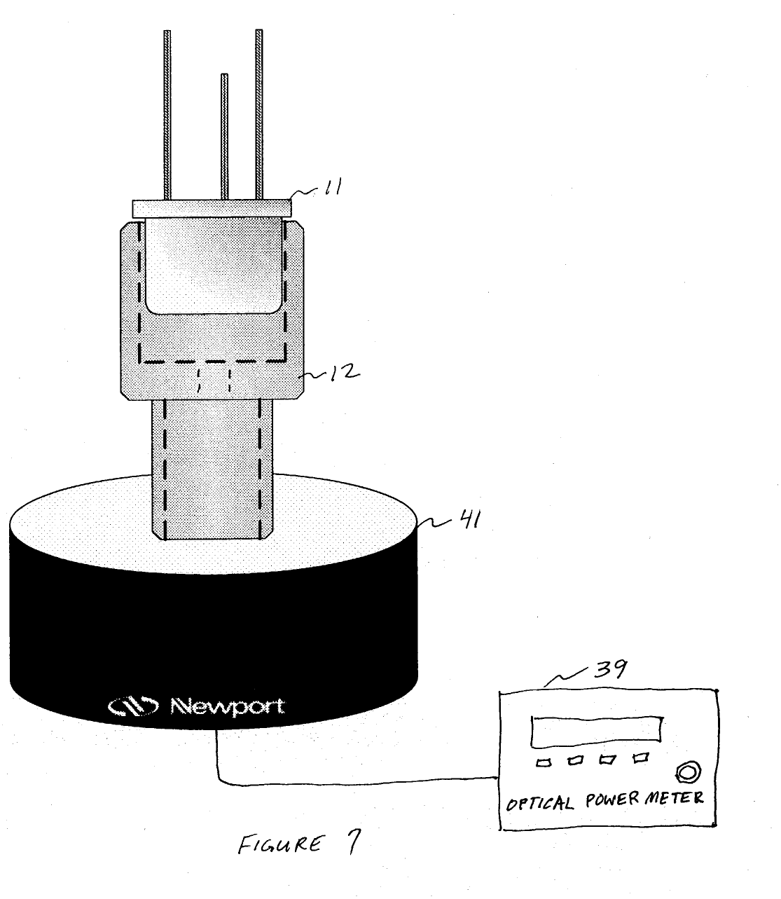

The purposes of the above-described structure and force dynamics are the determining alignment of a connectorized optical component with its optical media. Component 11 may be a source of radiated power or it may be a detector of radiation. For purposes of illustrating the present invention, component 11 may be an optical power source such as a vertical cavity surface emitting laser and medium 16 may be an optical fiber. To determine alignment properties, various power readings may be taken. First, receptacle 12, with component 11 inserted firmly in place, may be placed with bore 13 adjacent to a photo detector 41 in FIG. 7. This detector may be a Newport™ brand or like product. The output of photodetector 41 may be connected to an optical power meter or source measure unit 39. Power meter 39 may be a Newport™ model Optical Power Meter 1830-C or a Keithley™ Source Meter, or the like. This measurement may be regarded as output power test. This test is performed with a particular current applied to component 11. It may be mainly to determine what power component 11 is capable of when sourced at the particular current. This output measurement may be regarded as the “total output power.” Different detectors may be used to make the various measurements to possibly save time, or the same detector may be used to make the various measurements in attempt to minimize an amount of hardware used.

Second, ferrule 14 may be inserted into bore 13 of receptacle 12. (FIGS. 2 and 4.) Ferrule 14 is maintained in bore 13 with an approximate force as provided by pneumatic ball slide 24. The constant force 37 may be in the z direction which is parallel with center axis 32. There generally are virtually no forces orthogonal to force 37. This arrangement of force may be applied to cylinder 20 and ferrule 14 for the duration of the test indicated here. The end of fiber 16 exiting cylinder 20 may be coupled to a photodetector 38 which in turn has an output connected to optical power meter or source measure unit 39. The same current, as used for the total output power test, may be used for this test. The test measures the power from component 11 through receptacle 12, ferrule 14 and fiber 16. The measured output from fiber 16 may be regarded as the “output coupled power.” The constant z direction force 37 and absence of forces orthogonal to the direction of force 37 may assure repeatability of tests with a constancy of results. With this setup, many other tests may be performed with a sweep that increments forward current of component 11 while measuring back monitor current of component 11. The support box or cylinder 20 may be held straight or parallel to axis 32 by bore 13 of receptacle 12. Support spring 22 may provide a cushion to assure that there is not an immediate overbearing force initially by ferrule 14 into bore 13 of receptacle 12. Also, spring 22 may enable ferrule 14 to be fully inside bore 13 and enable support block or cylinder 20 to match any tilt bore 13 may have in order to make the test and its results repeatable.

The third test may be regarded for getting a measurement of “coupled power deviation”. This test may be used to detect gross misalignments between the fiber 16 end in ferrule 14 and the output or input of component 11. The setup for this test may be the same as the setup for the “output coupled power” test as noted above except along with the approximately constant force 37 being applied in the z direction on support block or cylinder 20, a rotating force 34 is applied while ferrule 14 is held in place in bore 13.

As forces 34 and 37 are applied, cylinder 20 and ferrule 14 wiggle or deviate around in a circular fashion as indicated by the deviation of axis 35 of cylinder 20 and ferrule 14 relative to center axis 32 of the bore 13, receptacle 12 and component 11 combination. The same particular current or different currents, depending upon test conditions or circumstances, as used in the tests for total output power and output coupled power, are applied to component 11. The end of fiber 16 from the end of cylinder 20 opposite of the end at ferrule 14, may be coupled to photodetector 38. The output of photodetector 38 is input to an optical power meter, current meter, or source measure unit 39 which may provide a measurement of power from fiber 16. During this test, a series or plurality of power measurements may be taken for instance as vector force 34 rotates about axis 32. A maximum power measurement may be selected from the series of power measurements and a minimum power measurement may be selected from the series of measurements.

A ratio of the highest power measurement to the lowest power measurement may be an indication of a “maximum coupled power deviation” between component 11 and fiber 16. This may be in decibels (dB). A ratio of minimum power measurement to the total output power measurement may indicate a “coupling efficiency” between component 11 and fiber 16, defined as a percentage or in dB.

A ratio of output coupled power at the particular current to the total output power at the same current may indicate a “simple coupling efficiency” between component 11 and fiber 16. These ratios may provide various indications of alignment and misalignment. The above-noted tests, measurements, ratios and misalignment/alignment determinations may be performed manually, semi-automatically or automatically.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A method for detecting misalignment of a component and a fiber, comprising:
activating a component within a receptacle at a first current and measuring a first power of a component's output with a first detector;
positioning a structure holding a fiber in a bore of the receptacle wherein a first end of the fiber is positioned approximately perpendicular to and approximately at the center of an output surface of the component;
activating the component at the first current and measuring a second output power at a second end of the fiber with a second detector; and
calculating a ratio of the second power to the first power.

2. The method of claim 1, further comprising:
activating the component at the first current;
moving the structure holding the fiber having the first end in a circle; and
obtaining a plurality of measurements of a third output power from the second end of the fiber with the second detector as the structure is moved about in a circle.

3. The method of claim 2, further comprising:
selecting the highest and the lowest measurements of the third output power; and
calculating a ratio of the highest measurement to the lowest measurement.

4. The method of claim 3, further comprising calculating a coupling efficiency from the lowest measurement of the third output power and the measured first power.

5. A system for determining misalignment of a component and a fiber, comprising:
a component;
a receptacle attached to said component;
a ferrule holding a fiber, insertable in said receptacle;
a support structure attached to said ferrule;
a slide connected to said support structure;
a first light detector proximate to the fiber;
a second light detector proximate to said receptacle; and
a rotator structure attachable to said support structure.

6. The system of claim 5, wherein:
said first light detector may make a first measurement of a first output of light from said component;
said ferrule may be inserted in said receptacle;
said slide may apply a first force in a direction approximately parallel to an axis of the fiber to maintain an insertion of said ferrule in said receptacle; and
said second light detector may make a second measurement of a second output of light from the fiber.

7. The system of claim 6, wherein:
said rotator structure may apply a second force having a direction approximately orthogonal to the first force, to said support structure and ferrule; and
the direction of the second force may rotate in a circle in a plane approximately orthogonal to the first force.

8. The system of claim 7, wherein said second light detector may make a plurality of third measurements of the second output of light while said rotator structure applies the second force to said support structure and ferrule.

9. The system of claim 8, wherein a first ratio of the second measurement to the first measurement is calculated.

10. The system of claim 8, wherein:
the highest and lowest third measurements are selected; and
a second ratio of the lowest third measurement to the highest third measurement is calculated.

11. The system of claim 8, wherein a third ratio of the lowest third measurement to the first measurement is calculated.

12. A method for detecting misalignment of a component, comprising:
attaching a component to a receptacle having an output bore opening;
measuring a first output power of the component at the output bore opening;
inserting a ferrule having a first end of a fiber, attached to a support structure, into the output bore opening;
measuring a second output power from the first end of the fiber;
moving the support structure and ferrule in a circle, the circle in a plane that is approximately perpendicular to a longitudinal axis of the fiber in the ferrule and support structure; and
measuring instances of the second output power from a second end of the fiber at various positions of the support structure and ferrule while being moved in a circle.

13. The method of claim 12, further comprising calculating a first ratio of the first power to the second power.

14. The method of claim 12, further comprising:
selecting the lowest and highest instances of the second output power; and
calculating a second ratio of the lowest and highest instances of the second output power.

15. The method of claim 12, further comprising calculating a third ratio of the lowest instance of the second output power and the first output power.

16. The method of claim 12, further comprising calculating a fourth ratio of the highest instance of the second output power and the first output power.

17. A device for measuring alignment comprising:
a holder having a first place for a component and a second place for a first end of a medium;
a support structure having a place for the medium;
a rotator structure attached to said support structure; and
a power measuring mechanism proximate to said holder and to a second end of the medium.

18. The device of claim 17, wherein said power measuring mechanism may take a measurement of a first power at the second place of said holder, of a component situated in the first place of said holder.

19. The device of claim 18, wherein said power measuring mechanism may take a measurement of a second power at the second end of the medium having the first end at the second place of said holder.

20. The device of claim 19, wherein:
said rotator structure may apply a force against said support structure; and
the force has a direction that rotates about a longitudinal axis of the medium.

21. The device of claim 20, wherein said power measuring mechanism may take measurements of a third power at the second end of the medium at various directions of the force.

22. The device of claim 21, wherein:
the lowest and highest measurements of the third power are selected;
a first ratio may be calculated of the lowest measurement of the third power and the measurement of the first power.

23. The device of claim 21, wherein a second ratio may be calculated of the measurements of the first and second powers.

24. The device of clam 21, wherein a third ratio is calculated of the lowest and highest measurements of the third power.

25. A device for measuring alignment and/or coupling efficiency, comprising:
a coupling structure having a first place for a component and a second place for a first end of a medium;
a rotator structure attached to the medium; and
a power indicator.

26. The device of claim 25, wherein said power indicator may provide an indication of a first power at the second place of said coupling structure.

27. The device of claim 26, wherein said power indicator may provide an indication of a second power at a second end of the medium.

28. The device of claim 27, wherein:
said rotator structure may apply a force against the medium; and
the force has a direction that rotates about a longitudinal axis of the medium.

29. The device of claim 28, wherein said power indicator may provide indications of a third power at the second end of the medium at various directions of the force.

30. The device of claim 29, wherein:
the lowest and highest indications of the third power are selected; and
a first ratio may be determined of the lowest and highest indications of the third power.

31. The device of claim 29, wherein a second ratio may be determined from the lowest indication of the third power and the indication of the first power.

32. The device of claim 29, wherein a third ratio may be determined from the indication of the first and second powers.

33. A means for determining alignment comprising:
means for holding a component;
means for holding a medium, wherein said means for holding a medium has a first end coupled to said means for holding a component; and
means for measuring power proximate to said means for holding a component.

34. The means of claim 33, further comprising means for applying a force at a second end of said means for holding a medium.

35. The means of claim 34, wherein:
a component may be placed in said means for holding a component; and
a medium may be situated in said means for holding a medium.

36. The means of claim 35, wherein:
said means for measuring power may measure a first power from the component at the first end of said means for holding a medium; and
said means for measuring power may measure a second power from an end of the medium proximate to the second end of said means for holding a medium.

37. The means of claim 36, wherein a first ratio is the second power to the first power.

38. The means of claim 36, wherein said means for applying a force at the second end of said means for holding a medium may apply a force in a plurality of directions around in a circle that is in a plane approximately perpendicular to a longitudinal axis of said means for holding a medium.

39. The means of clam 38, wherein said means for measuring power may take a plurality of measurements of a third power from the end of the medium proximate to the second end of said means for holding a medium, corresponding to the force applied at the second end of said means for holding a medium in a plurality of directions, respectively.

40. The means of claim 39, wherein:
the lowest and highest measurements are selected from the plurality of measurements of the third power; and
a second ratio may be determined from the lowest and highest measurements of the third power.

41. The means of claim 39, wherein:
the lowest measurement is selected from the plurality of measurements of the third power; and
a third ratio may be determined from the lowest measurement of the third power and a measurement of the first power.

42. A system for determining misalignment of a component and a fiber, comprising:
a component having a first detector;
a receptacle attached to said component;
a ferrule holding a fiber, insertable in said receptacle;
a support structure attached to said ferrule;
a moveable structure connected to said support structure; and
a rotator structure attachable to said support structure.

43. The system of claim 42, wherein:
a second light detector may make a first measurement of a first output of light from the fiber of said ferrule;
said ferrule may be inserted in said receptacle;
said moveable structure may apply a first force in a direction approximately parallel to an axis of the fiber to maintain an insertion of said ferrule in said receptacle; and
the first light detector may make a second measurement of a second output of light from the fiber of said ferrule.

44. The system of claim 43, wherein:
said rotator structure may apply a second force having a direction approximately orthogonal to the first force, to said support structure and ferrule; and
the direction of the second force may rotate in a circle in a plane approximately orthogonal to the first force.

45. The system of claim 44, wherein the first light detector may make a plurality of third measurements of the second output of light while said rotator structure applies the second force to said support structure and ferrule.

46. The system of claim 45, wherein a first ratio of the second measurement to the first measurement is calculated.

47. The system of claim 45, wherein:
the highest and lowest third measurements are selected; and
a second ratio of the lowest third measurement to the highest third measurement is calculated.

48. The system of claim 45, wherein a third ratio of the lowest third measurement to the first measurement is calculated.

49. A method for detecting misalignment of a component and a fiber, comprising:
activating a component within a receptacle at a first current and measuring a first power of a component's output with a detector;
positioning a structure holding a fiber in a bore of the receptacle wherein a first end of the fiber is positioned approximately perpendicular to and approximately at the center of an output surface of the component;
activating the component at the first current and measuring a second output power at a second end of the fiber with the detector; and
calculating a ratio of the second power to the first power.

50. The method of claim 49, further comprising:
activating the component at the first current;
moving the structure holding the fiber having the first end in a circle;
obtaining a plurality of measurements of a third output power from the second end of the fiber with the second detector as the structure is moved about in a circle;
selecting the highest and the lowest measurements of the third output power; and
calculating a ratio of the highest measurement to the lowest measurement.
